(19) United States
(12) Patent Application Publication
(10) Pub. No.: US 2026/0176524 A1
(43) Pub. Date: Jun. 25, 2026

(54) MICROFLUIDIC SYSTEM AND METHOD FOR PRODUCING PLANT-POLYMER PROPPANTS FOR OIL AND GAS OPERATIONS

(71) Applicant: SAUDI ARABIAN OIL COMPANY, Dhahran (SA)

(72) Inventors: Iaroslav Rybkin, Moscow (RU); Maxim Orlov, Moscow (RU); Qasim Sahu, Thuwal (SA)

(73) Assignees: SAUDI ARABIAN OIL COMPANY, Dhahran (SA); Aramco Innovations LLC, Moscow (RU)

(21) Appl. No.: 18/832,771

(22) PCT Filed: Oct. 20, 2023
(86) PCT No.: PCT/RU2023/000321

§ 371 Date: Jul. 24, 2024

(51) Int. Cl. C09K 8/80; C09K 8/60; C09K 8/78

(52) U.S. Cl. CPC C09K 8/80; C09K 8/602; C09K 8/78

(57) ABSTRACT

A system and method are described for making a proppant. The system includes a plurality of pumps for a first solution with an emulsion stabilizer, a matrix polymer, and a monomer; a second solution with an initiator, and a plant-based filler. The system includes a microfluidic device with a plurality of channels that receive the solutions, at least one channel junction where the solutions mix to form an emulsion, and a collecting zone. The process includes dissolving a matrix polymer, an emulsion stabilizer, and a monomer in a solvent to form a first solution and dissolving an initiator in another solvent to form a second solution, then adding a plant-based filler to the first or second solution, then feeding the solutions to a microfluidic device to form an emulsion, polymerizing the emulsion to form a proppant, and collecting the proppant.

### BACKGROUND

Proppants are materials used in hydraulic fracturing in the oil and gas industry to stimulate production in hydrocarbon-containing formations. Proppants are traditionally made from silica, ceramics, glass beads, resin-coated sands, and bauxites. The material used for proppants may result in properties of resistance to downhole heats and pressures.

Conventionally, proppants may be prepared using methods of crushing, sieving, coating, or sintering. Proppants may be spherical in shape and have a size distribution ranging from microns to millimeters. The method of preparation controls the shape and size distribution of the proppants.

Proppants may be included in fracturing fluid to stimulate production by hydraulic fracturing. The proppants are suspended in the fracturing fluid to maintain the opening of the fractures in the formation, increasing hydrocarbon production. There exists a need to develop proppants that maintain suspended in fracturing fluid while retaining resistance to downhole pressures.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a system for making a proppant. The system may include a plurality of pumps that provide a first solution of an emulsion stabilizer, a matrix polymer, and a monomer. The plurality of pumps may also provide a second solution of an initiator. The system may include a plant-based filler. The system may further include a microfluidic device. The microfluidic device may have a plurality of channels that separately receive the first solution and the second solution from the plurality of pumps. The microfluidic device may have at least one channel junction where the first solution and the second solution mix to form an emulsion. The system may further include a collecting zone.

In another aspect, embodiments herein relate to a process of preparing a proppant. The process may include dissolving a matrix polymer, an emulsion stabilizer, and a monomer in a solvent to form a first solution. The process may include dissolving an initiator in another solvent to form a second solution. The first solution and second solution may be immiscible. The process may include adding a plant-based filler to the first or second solution. The process may then include feeding the first and second solutions to a microfluidic device to form an emulsion. The process may then include polymerizing the emulsion to form a proppant and collecting the proppant from the microfluidic device.

In another aspect, embodiments herein relate to a treatment fluid. The treatment fluid may have a plurality of proppants. The plurality of proppants may each have a plant-based filler, a matrix polymer, and a monomer. The plurality of proppants may have a narrow size distribution. The narrow size distribution may be a ratio of standard deviation to mean less than about 30%.

Other aspects and advantages of the claimed subject matter will be apparent from the following description and the appended claims.

### BRIEF DESCRIPTION OF DRAWINGS

FIG. 1 is a depiction of a system for making a proppant in accordance with one or more embodiments.

FIG. 2 is a depiction of a process for making a proppant in accordance with one or more embodiments.

FIG. 3 is a depiction of a formation with hydraulic fractures in accordance with one or more embodiments.

### DETAILED DESCRIPTION

Embodiments of the present disclosure relate to a system and process for preparing proppants and a treatment fluid including the proppants. The system and process disclosed herein may provide a proppant of narrow size distribution, using a plant-based filler in combination with a microfluidic device. The proppant may be ultra-lightweight. An ultra-lightweight proppant may result from adding a plant-based filler. Herein the term “ultra-lightweight” refers to a proppant having a density of 1.05-1.75 g/cm³. An ultra-lightweight proppant is a type of proppant that is substantially lighter than traditional proppant. The microfluidic device may control the narrow size distribution of the produced proppants. A narrow size distribution may result when the parameters of the microfluidic device and emulsion formed therein are suitably chosen. The parameters may include the size of the channels in the microfluidic device. The parameters may further include the flow rate, the shear stress, the channel geometry, the fluid properties, the mixing, the operating pressure, and the droplet formation in the microfluidic device. In one or more embodiments, the proppants produced from a system and process described here may have a narrow size distribution. In one or more embodiments, the proppants have a narrow size distribution of particle sizes with a ratio of standard deviation to mean less than about 30%.

The proppant disclosed herein may be used in a treatment fluid that is a fracturing fluid for hydraulic fracturing. The use of proppants in the fracturing fluid aids the treatment fluid to stimulate hydrocarbon production in hydrocarbon-containing formations. Proppants may be added to prevent a fracture in a formation from closing. Proppants need to resist a high closure pressure, which may conventionally be achieved by increasing the density of the proppant. The high density may increase settling of proppants and decrease the efficiency of hydraulic fracturing. High density may require application of viscous fluids for transporting proppants into a formation and keeping them suspended. This may increase the power consumption and the load on transportation pumps used to transport the fluids. Through use of the present treatment fluid, the increase in power consumption and load on the transportation pumps may be reduced by the use of proppants with lower density and narrow size distribution. A lower density and narrow size distribution may result in maintaining suspension of the proppants within the fractures of the formation.

Specific embodiments of the system will now be described in detail with reference to the accompanying figures. Like elements in the various figures are denoted by like reference numerals for consistency. While only a limited number of examples are shown in the figures, it is recognized to one having ordinary skill in the art that the examples are non-limiting and components described herein may be modified.

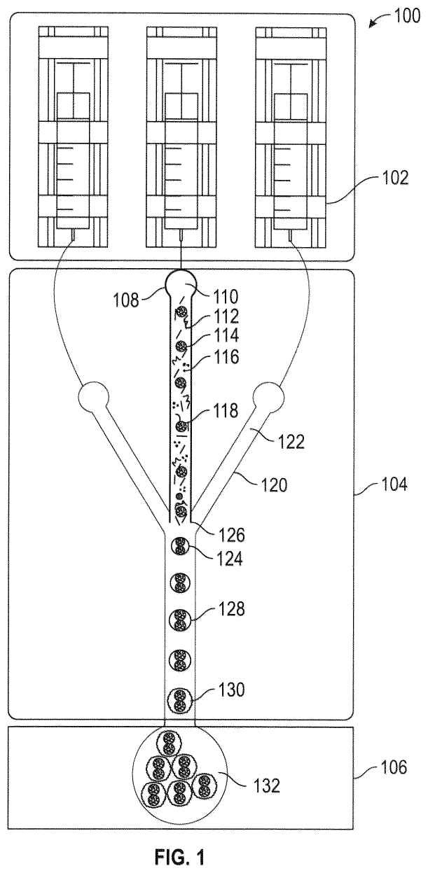

A system for making a proppant according to one or more embodiments is depicted in FIG. 1. The system 100 includes a plurality of syringe pumps 102, a microfluidic device 104, and a collecting zone 106. The collecting zone 106 may include a collecting reservoir 132. While illustrated with a collecting reservoir 132 in FIG. 1, it will be understood that the collecting zone 106 may not include a collecting reservoir 132. According to one or more embodiments, the microfluidic device 104 includes a plurality of channels and at least one channel junction.

Microfluidic devices are known to those of ordinary skill in the art to offer precise tuning and control of parameters during the formation of microspheres. Proppants described herein may take the form of microspheres. The high precision of the particle size distribution (e.g., a narrow particle size distribution) is achieved through the use of a microfluidic device 104. The narrow size distribution may result when the parameters of the microfluidic device are suitably chosen. The parameters may include the dimension of the plurality of channels in the microfluidic device 104, the flow rate ratio, the shear stress, the channel geometry, the fluid properties, the mixing, the operating pressure, and the droplet formation. The flow rate ratio may be varied to result in changes in the relative sizes of the proppant, thus affecting the overall size distribution of the proppant. Higher shear stress in the microfluidic channels may lead to more uniform size distribution, while lower shear stress may result in a broader range of sizes. Factors such as channel width, depth, and curvature of the channel geometry may impact the breakup and coalescence of droplets, affecting the resulting size distribution. Fluid properties of higher viscosity or surface tension may lead to a narrower size distribution, while lower viscosity or surface tension may result in a broader range of sizes. Poor mixing of fluid in the channels may lead to variations in shell thickness and, consequently, different proppant sizes. Higher pressures may result in a narrower size distribution, while lower pressures may lead to a wider range of sizes. Additionally, the droplet formation method may also affect the proppant properties. The droplet formation method used to generate droplets within the microfluidic device, such as flow-focusing, T-junction, or co-flow, may influence the size distribution of the proppant.

Referring back to FIG. 1, according to one or more embodiments, the system 100 includes a plurality of syringe pumps 102. Each of the syringe pumps 102 in the system contains a solution. The syringe pumps 102 are temperature controlled and are configured to provide the solutions to the microfluidic device 104. The syringe pumps 102 may have a feed rate control unit for precise dosing and a mixer to maintain distribution of the components. The syringe pumps 102 may be operated in parallel to maintain a constant supply of the solutions.

The system 100 is configured to move the solutions from the syringe pumps 102 to the plurality of channels, for example channel 108 and 120. The channel 108 contains a first solution 110. The first solution 110 includes a matrix polymer 112, a monomer 114, a cationic binder 116, a plant-based filler 118, and a solvent. The channel 120 contains a second solution 122. The second solution 122 includes an initiator 124 and another solvent. The channel 108 and channel 120 meet at a channel junction 126. An angle between channel 108 and channel 120 is from about 10° to about 90°, or from about 30° to about 60°, such that flows of the solutions in channels 108 and 120 are not disrupted. The channels 108 and 120 may formed from glass, metal, polymer, or silicon, and have a size of 30 microns to about 1 millimeter (mm).

According to one or more embodiments, the system 100 is configured so the first solution 110 from the channel 108 mixes with the second solution 122 from the channel 120 to make an emulsion. The term “emulsion” is used to describe a fine dispersion of one liquid in another in which the liquids are immiscible. The term emulsion, as used herein, includes sub-micron emulsion, microemulsion, mini-emulsion, normal emulsions, and suspensions. The emulsion formed at the channel junction 126 may be a two-phase emulsion, for example, a discontinuous internal water phase in a continuous oil phase (W/O), or discontinuous oil phase in a continuous water phase (O/W). The emulsion may be even more complex with a third internal phase, thus allowing to form a W/O/W or O/W/O type of emulsions.

The system is configured to move a hardening proppant 128 through the collecting zone 106 to the collecting reservoir 132. The system 100 is configured so that the hardening proppant 128 becomes the formed proppant 130 while in the collecting zone 106. As will be explained in greater detail below, a resin is formed around each hardening proppant particle 128 in the microfluidic system described herein. Initially, the resin is in an uncured/soft state on the hardening proppant particle 128, but as it cures, it hardens around the proppant particle to form the formed proppant 130. In one or more embodiments, the system is configured to separate the formed proppant 130 in a separate zone (not shown in FIG. 1). The separation may include using a sieve for separating the formed proppant 130 from unreacted emulsion. The sieve may have a mesh size equal to or greater than 20 microns and may be selected based on the size of the formed proppant 130. During collection, the system may be configured to air dry the proppant with hot hair. The hot air may be supplied by a heated element such as heated spirals or hot exhaust gases.

In one or more embodiments, the system is configured to move the formed proppant 130 formed in the channel junction 126 to the collecting zone 106. The collecting zone 106 may further include an evaporation unit (not shown) for evaporation of an organic solvent. The solvent in the first solution 110 and/or the solvent in the second solution 122 may be organic. The evaporation unit may be located on a plate with temperature control. At the evaporation unit, the organic solvent is evaporated and the proppant forms. The formed proppant 130 is collected at a collecting reservoir 132. The microfluidic device 104 and the collecting zone 106 may be fabricated on a microfluidics chip.

In one or more embodiments, the system includes a channel 108 containing a first solution 110. The first solution 110 includes a matrix polymer 112, a monomer 114, a cationic binder 116, a plant-based filler 118, and a solvent. The solvent may be aqueous. The solvent may include water. The solvent may further include co-solvents with water. The co-solvents may include acetone or ethanol. In one or more embodiments, the system includes a channel 120 containing a second solution 122. The second solution 122 includes an initiator 124 and another solvent. The solvent may be organic. The organic solvent may be dimethylformamide or dichloromethane. The choice of the solvents depends on the solubility properties of the other components of the first solution 110 and the second solution 122. In one or more embodiments, the system includes a plurality of syringe pumps 102, each containing an aqueous solution or a non-aqueous solution, based on needs of desired proppant production. For example, the system may include three syringe pumps, one of which contains an aqueous solution, and two of which contain non-aqueous solutions dissolved in same or different organic solvents. In another example, the system may include three syringe pumps, one of which contains an aqueous solution, one of which contains a non-aqueous solution dissolved in an organic solvent, and one of which contains a reagent of interest without addition of solvent.

In one or more embodiments, the first solution 110 includes a matrix polymer 112. The use of the matrix polymer 112 is an effective solution for holding the plant-based filler 118 within the proppant. The matrix polymer 112 is a viscous media, in which the plant-based filler 118 may be dispersed throughout. As will be described in further detail below, the matrix polymer 112 may be polymerized, producing a rigid structure. The rigid structure may then hold the plant-based filler in its dispersed state throughout the matrix polymer 112. In one or more embodiments, the matrix polymer 112 is selected based on thermo-mechanical properties that result in withstanding the temperatures and pressures known to occur during hydraulic fracturing.

The matrix polymer 112 may be a resin or a thermosetting polymer. The resin or thermosetting polymer may include at least one polymer formed from a melamine-formaldehyde, a urea-formaldehyde, a phenol-formaldehyde resin, a melamine-phenol-formaldehyde resin, a furan-formaldehyde resin, an epoxy resin, a furan resin, a phenolic resin, a polyester resin, a vinyl ester resin, a polydicyclopentadiene, a polyurethane, a polyuria, a polyimide, benzoxazines, bismaleimides, a polyimide resin, allyl resins and combinations thereof. The matrix polymer 112 may also be polysiloxane.

In one or more embodiments, the first solution 110 includes a monomer 114. The monomer 114 may be polymerized with the matrix polymer 112 to form a final polymer. The monomer 114 may also hold or encapsulate the plant-based filler 118 in the matrix polymer 112. The monomer 114 may also form an outside shell around the matrix polymer 112 and plant-based filler 118.

The monomer 114 may include curable monomers. Curable monomers may cure/harden when exposed to chemical agents (e.g., an initiator), physical cross-linking (e.g., ionic interaction with other monomers and/or polymers), or external stimuli (e.g., UV light exposure). Curable monomers may be divinylbenzene, 4-vinylbenzyl chloride, dimethylaminoethyl methacrylate, glycidyl acrylate, glycidyl methacrylate, allylalcohol monoallyl ethers, 2-hydroxyethyl methacrylate, and combinations thereof.

The monomer 114 may also include non-curable monomers. Non-curable monomers may be added in addition to the curable monomers. Non-curable monomers may not undergo crosslinking but can contribute to useful properties of the first solution and resultant proppant particles. For example, addition of non-curable monomer may affect adhesion, thermal and mechanical properties, flexibility and morphology of the resultant polymer. Non-curable monomers may be vinyl neodecanoate, tert-dodecylthiol, acrylic acid, acrylic esters, methacrylic acid, methacrylic esters, vinylpyridine, acrylamide, t-butyl-aminoethyl methacrylate, allyl-glycidyl ether, 2-hydroxypropyl acrylate, 2-hydroxypropyl methacrylate, methacrylic acid, itaconic acid, methacrylamide, maleiamide, maleic anhydride, itaconic anhydride, vinyl isocyanate, allyl isocyanate, and combinations thereof.

The polymerization of the monomer 114 and the matrix polymer 112 may form polymers of poly(divinylbenzene-co-4-vinylbenzyl chloride), poly(divinylbenzene-co-dimethylaminoethyl methacrylate), poly(divinylbenzene-co-2-hydroxyethyl methacrylate), poly(divinylbenzene-co-maleic anhydride), poly(divinylbenzene-co-styrene, epoxy resin modified with glycidyl acrylate, urea-formaldehyde resin cross-linked with divinylbenzene, poly(styrene/acrylate)-polyester, polyurethane/poly (2-hydroxyethyl methacrylate) and combinations thereof as the final polymer.

In one or more embodiments, the first solution 110 includes a plant-based filler 118. In other embodiments, the plant-based filler 118 is included in the second solution. The choice of solution for the plant-based filler depends on the type of polymerization. For example, if the polymers for the matrix polymer 112 are oil-soluble, the plant-based filler 118 may be dispersed in an oil phase. In one or more embodiments, the plant-based filler 118 includes plant material. Plant material is highly fibrous, owing to the lignin, cellulose, and hemi-cellulose molecules present. The fibers, when included in a proppant, may lead to an increase in the mechanical strength of the material, without the significant addition of mass. An increase in mass may lead to settling of the proppant, which is undesirable. In one or more embodiments, the plant-based filler includes plants, wood, invasive plant species, bio-based waste, organic sludge, grass, seeds, wooden chips, and combinations thereof. In one or more embodiments, the plant-based filler 118 includes plant based-derivatives consisting of lignin, a lignin derivative, cellulose, a cellulose derivative, hemicellulose, a hemicellulose derivative, starch, a starch derivative, inulin, an inulin derivative, Kraft lignin, a Kraft lignin derivative, and combinations thereof. The plant-based filler may be a recycled plant-based material. The recycled plant-based material may be recycled plants, recycled wood, recycled invasive plant species, recycled bio-based waste, recycled organic sludge, recycled grass, recycled seeds, recycled wooden chips, and combinations thereof. The recycled material may be from the paper industry, the wood industry, the food industry (for nut shells), and combinations thereof.

In one or more embodiments, the first solution 110 includes an emulsion stabilizer. The emulsion stabilizer may have structural characteristics important for its role in forming the proppant. One structural characteristic is hydrophilic-lipophilic balance (HLB). Compounds with different HLB values may often be used to achieve emulsion stability. Another structural characteristic is ethoxylated or polymeric structures. Compounds like ethoxylated alcohols, alkylphenol ethoxylates, and polyethylene glycol (PEG) derivatives possess ethoxy or polymeric chains, which may contribute to their emulsion stabilizing properties. Another structural characteristic is the presence of sulfonate or sulfate groups. Sulfonate or sulfate groups may include alkyl aryl sulfonates or alkyl ether sulfates. Another structural characteristic may be the ionic nature. Compounds with ionic groups, such as ammonium, sodium, or quaternary ammonium salts, may exhibit electrostatic interactions at the interface, promoting emulsion stability. The use of the emulsion stabilizer may improve the emulsion stability by preventing coalescence and aggregation. The emulsion stabilizer may also improve the particle size control and therefore also contribute to controlling the particle size distribution of the proppant.

The emulsion stabilizer may be a surfactant. The surfactant may include fatty acids, amino alcohols, fatty alcohols, fatty mercaptans, polyethylene glycol, polypropylene glycol, polyvinyl alcohol, polysorbates, fatty acid esters of sorbitol, fatty acid esters of glycerol, fatty acid esters of polyhydroxy compounds, alkylphenol ethoxylates, alkyl polyglucosides, fatty alcohol ethoxylates, ethoxylated amines and/or fatty acid amides, cetrimonium bromide, octenidine dihydrochloride, dioctadecyldimethylammonium bromide, cetylpyridinium chloride, benzalkonium chloride, benzethonium chloride, dimethyldioctadecylammonium chloride, ammonium lauryl sulfate, sodium lauryl sulfate, ammonium dodecyl sulfate, sodium dodecyl sulfate, sodium lauryl ether sulfate, sodium myreth sulfate, dioctyl sodium sulfosuccinate, perfluorobutanesulfonate, alkyl-aryl ether phosphates, alkyl ether phosphates, alkyl aryl sulfonates, alkyle benzene sulfonates, alkyl sulfates, N-ethoxy sulfonates, sodium dodecyl sulfates, alcohol propoxy sulfates, alkyl ethoxy sulfates, alpha-olefin sulfonates, alpha-olefin sulfates, branched alkyl benzene sulfonates, docusate sodium, ethoxy glycidyl sulfonates, propoxy glycidyl sulfonates, alkyl ether sulfates, internal olefin sulfonates, sulfonated ethoxylated alcohols, sulfonated ethoxylated alkyl phenols, sodium petroleum sulfonates, alkyl alcohol propoxylated sulfates, alkyl phenols, monoglycerides, diglycerides, guar gum, canola oil, lecithin, carrageenan, ammonium phosphatide, derivatives and combinations thereof.

In one or more embodiments, the first solution 110 further includes a cationic binder 116. The electrostatic interaction between the plant-based filler 118 and the cationic binder 116 may form strong particle-polymer associates, which may increase the mechanical strength of the proppant. The cationic binder 116 may be an amine polymer. The amine polymer may include: (i) primary amines, (ii) secondary amines, (iii) tertiary amines, and/or (iv) quaternary amines derivatives and combinations thereof. The cationic binder may be natural or synthetic. Natural polymers may include biomolecules consisting of positively charged amino acids, proteins, polysaccharide containing amino groups, amino sugars. Natural and synthetic polymers and derivatives may also be used in combination. The polymer-particle associates are formed from electrostatic interactions between positively charged amine functionalities of the cationic binder 116 and negatively charged functionalities of the plant-based filler 118. The negatively charged functionalities of the plant-based filler 118 may be due to the presence of hydroxyl groups, carboxylic acid groups, and/or phosphate groups.

In one or more embodiments, the system includes a channel 120 containing a second solution 122. The second solution 122 includes an initiator 124. The initiator 124 may activate polymerization of the matrix polymer 112. The initiator 124 may further activate polymerization of the matrix polymer 112 and the monomer 114. The initiator 124 may initiate polymerization of the primary polymer chain (i.e., elongating the polymer chain). The initiator 124 may also initiate branching of the polymer chains, resulting in crosslinking. Polymerization with the initiator 124 may result in the plant-based filler 118 being embedded within the matrix polymer 112. As noted above, the cationic binder 116 may also assist in the support for the plant-based filler 118. The initiator 124 may include persulfates, peroxides, organic peroxides, and azo dyes including but not limited to thermal radical initiators, thermal cationic initiators, photo-radical initiators, photo-cationic initiators, photo-anionic initiators, redox initiators, persulfate initiators.

According to one or more embodiments, the microfluidic device 104 includes a plurality of channels, each allowing flow of one or more solutions, and at least one channel junction, where two or more channels converge. The converging channels may contain immiscible solutions, and the immiscible solutions are mixed at the channel junction to form an emulsion. The formed emulsion may continue to flow in subsequent channels toward the collecting zone 106. At the channel junction 126, any two channels containing different solutions may be disposed at an angle of from about 10° to about 90°, or from about 30° to about 60°, such that the flows of the different solutions in the two channels maintain in an optimal direction and speed.

According to one or more embodiments, the plurality of channels is of a certain dimension. The dimension of the plurality of the channels may affect the formed proppant 130 size. In one or more embodiments, the plurality of channels has a length in the range from 2 millimeters (mm) to 10 centimeters (cm). Shorter channels may offer shorter diffusion paths, which may enable faster mixing and reaction between the monomer 114 and initiator 124. This may result in faster polymerization and the formation of smaller proppant.

In one or more embodiments, the plurality of channels has a width in the range from 10 microns to 1 mm. In other embodiments, the plurality of channels has a depth in the range of 2 microns to 2 mm. Narrower channels may generate higher flow rates and increased shear forces, which may promote more efficient mixing of the monomer 114 and matrix polymer 112 with the plant-based filler 118. Shorter residence times in narrower channels may restrict the polymerization process and favor the formation of smaller proppant.

An overall smaller dimension of the plurality of channels may affect the formed proppant 130 size. Smaller herein refers to both a shorter length and a narrower width and depth. Smaller channels may restrict the movement and diffusion of the emulsion, resulting in a more confined environment for polymerization. This confinement effect may lead to the formation of smaller proppant. Smaller channel sizes may enhance capillary forces, which may promote the formation of smaller droplets during the emulsification process.

In one or more embodiments, the first solution 110 and the second solution 122 may form an emulsion at a channel junction 126 of the microfluidic device 104. The formed emulsion may have two phases: a dispersed phase (in form of droplets) and a continuous phase (in form of liquid surrounding the droplets). The emulsion may be classified as oil-in-water (O/W) or water-in-oil (W/O), depending on whether the continuous phase is water or oil. In the present disclosure, an “oil” phase, if not otherwise specified, refers to a non-aqueous solution described in one or more embodiments of the present disclosure. A “water” phase, if not otherwise specified, refers to an aqueous solution described in one or more embodiments of the present disclosure. The type of emulsion may be controlled by the composition and ratio of the dispersed phase (e.g., oil) to the continuous phase (e.g., water). Varying the relative amounts of the two phases may promote the formation of either O/W or W/O emulsions. In particular embodiments, a W/O/W or O/W/O emulsion may be formed. However, the formation of such complex emulsions is more challenging to achieve and typically requires the inclusion of additional channels for forming an additional phase of the emulsion. In such embodiments, the microfluidic device 104 has a second channel junction for the formation of a W/O/W or O/W/O emulsion.

The microfluidic device 104 may be fabricated on a microfluidics chip. The microfluidics chip may be fabricated by etching or molding the microchannel network into a material using methods known in the art. For example, the fabrication method may be soft lithography, injection molding, hot embossing, laser ablation, photolithography, additive manufacturing, or micro-milling. The material used for the microfluidics chip may include polymers, ceramics, semiconductors, and metals. In one or more embodiments, the microfluidics chip is made from polydimethylsiloxane (PDMS), glass, polymethylmethacrylate (PMMA), and combinations thereof. The microfluidics chip may include a sacrificial substrate, such as a carbonate material, that can be removed after the chip has been fabricated. In one or more embodiments, the microfluidics chip has dimensions in the range from a few square millimeters (mm²) to a few square centimeters (cm²).

According to one or more embodiments, microfluidic device 104 is in fluid communication with collecting zone 106, configured to collect the formed proppant 130. The system 100 may further be configured for separation of the formed proppant 130 from unreacted emulsion (not shown in FIG. 1). The separation may be performed with a sieve. The sieve may be separate from the microfluidic device 104.

As noted above, in some embodiments, an evaporation unit may be included to evaporate solvent from the formed proppant 130, however it is not necessarily present. The evaporation unit may be located in the collecting zone 106 (not pictured in FIG. 1). The evaporation unit may be coupled to a plate with temperature control, configured to provide an elevated temperature to increase an evaporate rate of the organic solvent. The evaporation unit may be coupled to a vacuum pump configured to generate a gradient of low pressure, so as to facilitate evaporation of the organic solvent and enable reuse of the organic solvent.

According to one or more embodiments, the collecting zone 106 includes a collecting reservoir 132. In one or more embodiments, the collecting reservoir 132 may be fabricated as a void space on a microfluidics chip. The microfluidic device 104 and the collecting zone 106 may be fabricated on the same microfluidics chip. Various shapes and sizes may be selected for the reservoir and may be optimized so as to balance a rate of emulsion formation a rate of polymerization and hardening.

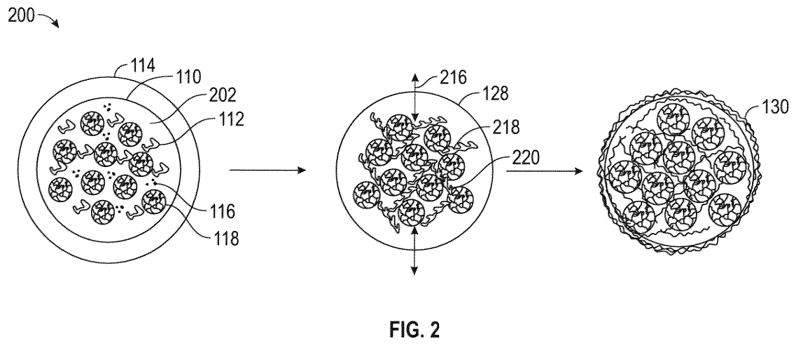

A process of making a proppant according to one or more embodiments is depicted in FIG. 2. In one or more embodiments, the process 200 for making a proppant includes dissolving a matrix polymer 112, an emulsion stabilizer 202, and a monomer 114 in a solvent to form a first solution 110. Next, the process includes dissolving an initiator 124 in another solvent to form a second solution 122, where the first solution 110 and second solution 122 are immiscible. Next, the process includes adding a plant-based filler 118. The plant-based filler 118 can be added to the first solution 110 or second solution 122. Then, the process includes feeding the first and second solution to a microfluidic device 104 to form an emulsion. Polymerizing the emulsion may produce formed proppant 130, where the last step of the process is collecting the formed proppant 130 from the microfluidic device 104.

The matrix polymer 112 may be dissolved in the first solution 110 in a suitable concentration for forming an emulsion. In one or more embodiments, the matrix polymer 112 is dissolved at a concentration of 5 to 50 percent weight by volume (w/v %). The matrix polymer 112 may be dissolved at a concentration with a lower limit of any one of 5, 10, and 15 w/v %, and an upper limit of any one of 16, 20, 30, 40, and 50 w/v %, where any lower limit may be paired with any mathematically compatible upper limit.

The emulsion stabilizer 202 may be dissolved in the first solution 110 in a concentration suitable for stabilizing the emulsion. In one or more embodiments, the emulsion stabilizer 202 is dissolved at a concentration of 0.01 to 0.1 w/v %. The emulsion stabilizer 202 may be dissolved at a concentration with a lower limit of any one of 0.01, 0.02, 0.03, 0.04, and 0.05 w/v %, and an upper limit of 0.06, 0.07, 0.08, 0.09, and 0.10 w/v %, where any lower limit may be paired with any mathematically compatible upper limit.

The monomer 114 may be dissolved in the first solution 110. The monomer 114 may also be dissolved in the second solution 122. The choice of solution depends on the type of emulsion in addition to the solubility of the matrix polymer 112 and the emulsion stabilizer 202. The monomer 114 may be dissolved in a suitable ratio to the matrix polymer 112 to increase the mechanical and thermal properties of the resultant proppant. In one or more embodiments, the monomer 114 is dissolved at a ratio of 10 w/v % monomer 114 to 90 w/v % matrix polymer 112.

The cationic binder 116 may be added to the first solution 110 in a suitable amount to provide binding properties for the plant-based filler. In one or more embodiments, the cationic binder 116 is included at a concentration of 0.01 to 5.0 w/v %. The cationic binder 116 may be included at a concentration with a lower limit of any one of 0.01, 0.04, 0.08, and 0.10 w/v %, and an upper limit of 0.11, 0.5, 1.0, 2.0, 3.0, 4.0, and 5.0 w/v %, where any lower limit may be paired with any mathematically compatible upper limit.

In one or more embodiments, a process for making a proppant includes dissolving an initiator 124 in another solvent to form a second solution 122. The initiator 124 may be included at a concentration of 0.1 to 5.0 w/v %. The initiator 124 may be included at a concentration with a lower limit of any one of 0.1, 0.5, 1.0, 1.5, 2.0, and 2.4 w/v %, and an upper limit of 2.5, 3.0, 3.5, 4.0, 4.5, and 5.0 w/v %, where any lower limit may be paired with any mathematically compatible upper limit.

In one or more embodiments, a process for making a proppant includes adding a plant-based filler 118. The plant-based filler 118 may be added to the first solution 110 or the second solution 122. Prior to use in the microfluidic device 104, the plant-based filler 118 may be prepared by grinding and sieving. Micron-sized particles of plant-based filler 118 may be formed. The micron-sized particles of plant-based filler 118 may undergo multiple rounds of grinding and sieving, so that the size of the particles is smaller than the channels 108 and 120, ranging from 30 μm to about 300 μm. In one or more embodiments, the plant-based filler 118 is added to the first solution 110 or the second solution 122 at a concentration from 0.5 up to 10 w/v %. The plant-based filler 118 may be added at a concentration with a lower limit of any one of 0.5, 1, 2, 3, 4, and 4.9 w/v %, and an upper limit of 5, 6, 7, 8, 9, and 10 w/v %, where any lower limit may be paired with any mathematically compatible upper limit.

In one or more embodiments, a process for making a proppant includes feeding the first solution 110 and the second solution 122 to a microfluidic device 104 to form an emulsion. The second solution 122 may include a solvent that is immiscible with the first solution 110. Immiscible solutions are solutions that do not form homogeneous solutions when combined. Each solution may be considered a phase, so that the emulsion may contain two phases. In one or more embodiments, the emulsion has a ratio of 1 of the first solution 110 to 1000 of the second solution 122. The emulsion may have a ratio having a lower limit of the first solution 110 of 1 to an upper limit of the second solution 122 of any of 1, 1.1, 2, 3, 10, 25, 50, 100, 200, 500 and 1000.

In one or more embodiments, a process for making a proppant includes polymerizing the emulsion. Polymerization 216 may be activated by an initiator 124. Polymerization 216 may include emulsion polymerization, mini-emulsion polymerization, sub-micron emulsion polymerization, microemulsion polymerization, suspension polymerization, colloid polymerization, interfacial polymerization, or emulsion cross-linking. Polymerization 216 may occur over a period of time from seconds to hours. The polymerization 216 may be conducted at an elevated temperature or at ambient temperature. For example, the temperature may be in a range of 20° C. to greater than 100° C. The temperature increase may be due to the polymerization 216 occurring through an exothermic reaction.

In one or more embodiments, the polymerization 216 is a reaction between polymers and/or monomers in the emulsion and the initiator 124. The initiator 124 may activate the polymerization using thermal, photo, redox and persulfate types of activators. The persulfate types of activators may include persulfate salts. Persulfate salts may be ammonium persulfate, potassium persulfate, sodium persulfate, lithium persulfate, barium persulfate, calcium persulfate, or magnesium persulfate. The initiator 124 may be dissolved in the second solution 122 prior to the formation of the emulsion at a channel junction 126.

According to FIG. 2, polymerization 216 results in a hardening proppant 128. Additional cross-linking 218 may occur due to elongating and branching polymer chains formed during polymerization interacting to form a crosslinked structure. Polymerization 216 may react the matrix polymer 112 containing the polymer-particle associates 220 with the monomer 114 to form a hardening proppant 128. As used herein, “polymer-particle associates” refers to electrostatic interactions between the cationic binder 116 and the plant-based filler 118. Once fully reacted, the hardening proppant 128 yields the formed proppant 130. In one or more embodiments, the formed proppant 130 includes the plant-based filler 118 held within the matrix polymer 112. The plant-based filler held inside the matrix polymer may result from physical adhesion of the plant-based filler 118 within the matrix polymer 112. In one or more embodiments when a cationic binder 116 is included, this effect results from electrostatic interactions between the cationic binder 116 and the plant-based filler 118. The formed proppant 130 may have a diameter in the range from 50 microns to 1 mm.

In one or more embodiments, a process of preparing a proppant includes collecting the formed proppant 130 at the collecting reservoir 132. The process may further include drying the proppant before collecting. Drying may include air drying by hot air. Hot air may be supplied by a heated element such as heated spirals or hot exhaust gases. The hot air may have a temperature of around 70° C. After collecting, the formed proppant 130 may be separated by sieving. Sieving may include removing unreacted emulsion and solutions from the formed proppant 130. The removed unreacted emulsion and solutions may be filtered and recycled for continued use.

One or more embodiments disclosed herein relate to the use of the ultra-light weight proppants in a treatment fluid. In one or more embodiments, a treatment fluid includes plurality of proppants each of the plurality of proppants comprising a plant-based filler, a matrix polymer, and a monomer, wherein the plurality of proppants has a narrow size distribution. The plurality of proppants are as described above.

The term “treatment fluid” may also refer to a fracturing fluid, which may include a chemical solution that is used in fracturing operations to increase the quantity of hydrocarbons that can be extracted. In such fracturing fluids, complex chemical solutions having sufficient viscosity properties may be included to generate fracture geometry in the formation rock and transport solid proppants holding the fracture open.

Treatment fluids are used in fracturing operations where the process usually involves several steps, including injection water, proppant, and other chemicals under high pressure into a hydrocarbon-bearing formation through a wellbore. This process is intended to create new fractures in the rock as well as increase the size, extent, and connectivity of existing fractures. Fracturing is also known as hydraulic fracturing and fracking. It is used commonly in low-permeability rocks like tight sandstone, shale, and some coal beds to increase oil and/or gas flow to a well from petroleum-bearing rock formations and to create improved permeability in underground geothermal reservoirs.

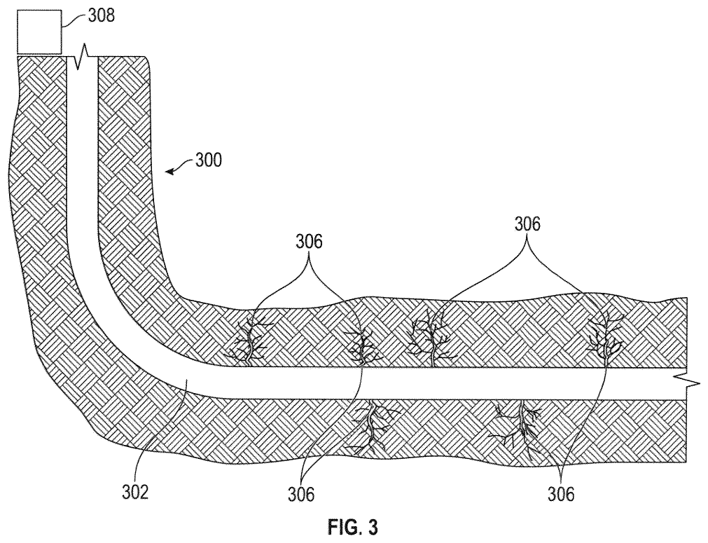

A wellbore system for use of the treatment fluid is depicted in FIG. 3. A wellbore 302 is disposed within the formation 300. The formation 300 is a geological formation from which drilling fluid such as oil or gas may be produced by drilling a wellbore and extracting the fluid from the formation. The wellbore 302 is a drilled hole suitable to extract hydrocarbons, gas, or water from the formation. The wellbore may include a casing 304 or be uncased (not shown) to form a producing well for the extraction. The formation 300 may have fractures 306. Fractures are separations or cracks in geological formations that divide one or more rocks. Fractures 306 may be microfractures, natural fractures, or hydraulic fractures. In one or more embodiments, the wellbore 302 contains a treatment fluid. A transportation pump 308 may be used to transport the treatment fluid into the formation 300. The plurality of proppants may be included in the treatment fluid at different concentrations. In one embodiment, the plurality of proppants is present in the treatment fluid in a range from 0.5 to 15 w/v %. The plurality of proppants may be present at a lower limit of any one of 0.5, 1, 2.3, 4.7, and 7.4 w/v % and an upper limit of 7.5, 8.5, 10, 12.5, and 15 w/v %, where any lower limit may be paired with any mathematically compatible upper limit. A treatment fluid according to one or more embodiments is introduced into a formation and transported during upstream operations of hydraulic fracturing. Once the pressure of the formation is reduced, the proppant settles and creates a permeable pathway for hydrocarbon flow. Thus, the proppants are used for propping open the fractures created in the rock formation.

Embodiments of the present disclosure may provide at least one of the following advantages. One advantage of a proppant made by the system and process described herein may be a reduction in proppant settling. Reducing proppant settling is advantageous as proppants need to remain suspended in the fractures within a formation to increase the hydrocarbon flow. The system and process for making a proppant described herein may result in a proppant that is ultra-lightweight and has a narrow size distribution. Both of these properties may reduce proppant settling.

The system and process of making a proppant including a microfluidic device may provide a high precision during the preparation. Microfluidic devices, like in one or more embodiments described herein, offer precise tuning and control of parameters during formation of microspheres and as a result, it may ensure a high precision of particle size distribution during production.

The system and process of making a proppant provide ultra-lightweight proppants having reduced density compared to conventional proppants. The decrease of proppant density allows the (i) reduction of proppant settling, (ii) use of lower viscosity fluids, (iii) reduction of pumping rates, which decreases the risk of unwanted fracturing of the formations, and (iv) minimization of fluid losses. Since the plant-based filler may be composed of complex and strong fibers it may preserve mechanical strength of proppants but not cause an increase in density. Thus, the proppants described herein are able to maintain suspension during hydraulic fracturing, without increasing the power consumption and the load on the pumps needed to transport the fluids. In addition, the fillers may have a lower environmental impact since a large amount of the materials may be sourced from waste. The waste may be obtained from paper plants, the wood industry, and the food industry,

Another advantage of using a proppant made from one or more embodiments described herein may be using lower viscosity fluids in the treatment fluid. Using lower viscosity fluids lowers the power consumption, the load on pumps, and the potential damage to the formation during fracturing operations. Additionally, the use of a proppant as described herein may lead to reduced pumping rates, which decreases the risk of unwanted fracturing of the formations. The system and process for making a proppant described herein may result in a proppant that is ultra-lightweight. The decrease in density of the ultra-lightweight proppant may result in lower viscosity fluids and less power consumption.

An additional advantage of using a proppant made from one or more embodiments described herein may be sustaining mechanical strength of the proppant without an increase in mass and density. Sustaining the mechanical strength may result from the use of a plant-based filler, as described in one or more embodiments herein. As the plant-based filler is composed of complex and strong fibers as lignin, cellulose, and hemicellulose, it may sustain the mechanical strength of the proppant without increasing the density.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A system for making a proppant, the system comprising:
a plurality of pumps that provide a first solution comprising an emulsion stabilizer, a matrix polymer, and a monomer; a second solution comprising an initiator; and a plant-based filler,
a microfluidic device comprising:
a plurality of channels that separately receive the first solution and the second solution from the plurality of pumps; and
at least one channel junction where the first solution and the second solution mix to form an emulsion; and
a collecting zone.

2. The system of claim 1, wherein the plant-based filler is added to the first solution or the second solution.

3. The system of claim 1, wherein the plant-based filler comprises a material selected from a group consisting of plants, wood, invasive plant species, bio-based waste, organic sludge, grass, seeds, wooden chips, and combinations thereof.

4. The system of claim 1, wherein the plant-based filler is a recycled material.

5. The system of claim 1, wherein the emulsion stabilizer comprises a surfactant.

6. The system of claim 1, wherein the matrix polymer comprises a thermosetting polymer or a resin.

7. The system of claim 1, wherein the monomer is curable.

8. The system of claim 1, wherein the initiator is selected from the group consisting of thermal radical initiators, thermal cationic initiators, photo-radical initiators, photo-cationic initiators, photo-anionic initiators, redox initiators, persulfate initiators, and combinations thereof.

9. The system of claim 1, wherein each channel in the plurality of channels has a length of 2 millimeters to 10 centimeters, a width of 10 microns to 1 millimeter, and a depth of 2 microns to 2 millimeters.

10. A process of preparing a proppant, the process comprising:
dissolving a matrix polymer, an emulsion stabilizer, and a monomer in a solvent to form a first solution;
dissolving an initiator in another solvent to form a second solution, wherein the solutions are immiscible;
adding a plant-based filler to the first or second solution;
feeding the first and second solutions to a microfluidic device to form an emulsion;
polymerizing the emulsion to enable formation of a proppant; and
collecting the proppant from the microfluidic device.

11. The process of claim 10, wherein the emulsion comprises at least two phases, each derived from the first or second solution.

12. The process of claim 10, further comprising adding a cationic binder to one of the solutions.

13. The process of claim 10, further comprising drying the proppant.

14. The process of claim 10, wherein collecting the proppant further comprises separating the proppant by sieving.

15. A treatment fluid comprising a plurality of proppants each comprising a plant-based filler, a matrix polymer, and a monomer, wherein the plurality of proppants has a narrow size distribution,
wherein the narrow size distribution is a ratio of standard deviation to mean less than about 30%.

16. The treatment fluid of claim 15, wherein treatment fluid comprises 0.5% to 15% of the plurality of proppants.

17. The treatment fluid of claim 15, wherein the plant-based filler comprises a material selected from a group consisting of plants, wood, invasive plant species, bio-based waste, organic sludge, grass, seeds, wooden chips, and combinations thereof.

18. The treatment fluid of claim 15, wherein the plurality of proppants further comprises an emulsion stabilizer, wherein the emulsion stabilizer is a surfactant.

19. The treatment fluid of claim 15, wherein the matrix polymer comprises a thermosetting polymer or a resin.

20. The treatment fluid of claim 15, wherein the monomer is curable.
